(19) United States
(12) Patent Application Publication
(10) Pub. No.: US 2007/0196268 A1
(43) Pub. Date: Aug. 23, 2007

(54) THERMAL ACTIVATION OF PHOTOCATALYTIC GENERATION OF HYDROGEN

(76) Inventors: John R. Smith, Birmingham, MI (US); Xiao-Gang Wang, Troy, MI (US); Thomas H. Van Steenkiste, Ray, MI (US)

Correspondence Address: CANTOR COLBURN, LLP, 55 GRIFFIN ROAD SOUTH, BLOOMFIELD, CT, 06002, US

(21) Appl. No.: 11/676,920

(22) Filed: Feb. 20, 2007

Related U.S. Application Data
(60) Provisional application No. 60/775,700, filed on Feb. 22, 2006.

(51) Int. Cl. C01B 3/08

(52) U.S. Cl. 423/657

(57) ABSTRACT

A method for thermally activating photocatalytic generation of hydrogen from water, comprising: mixing a catalyst comprising a plurality of nanoparticles into a volume of water, wherein H₂O molecules adsorb onto the surface of the plurality of nanoparticles to form OH complexes, wherein the diameters of the plurality of nanoparticles are less than 35 nanometers; exposing the solution to sunlight, wherein the temperature of the solution is increased to be within the range of 110 to 140 degrees Fahrenheit; and generating a plurality of electron hole pairs in the plurality of nanoparticles of the catalyst, wherein the electron hole pairs assist in the weakening of OH complexes on the surface of the plurality of nanoparticles to cause hydrogen atoms to thermally desorb from the OH complexes.

### CROSS REFERENCE TO RELATED APPLICATIONS

This application claims the benefit of U.S. Provisional Patent Application Ser. No. 60/775,700, filed Feb. 22, 2006, the contents of which are incorporated herein by reference thereto.

### BACKGROUND

The present invention relates to a green or clean energy source. More particularly, exemplary embodiments of the present invention relate to methods and compositions for photocatalytic decomposition of water using thermal activation.

The world's current carbon-based energy supply generates by-products that pollute the land, oceans and air of our planet. As an alternative fuel source hydrogen has been gradually emerging. However, for hydrogen to completely replace or supplement a carbon based energy supply, an economical source or method of producing hydrogen is required.

Prior attempts have generated hydrogen via electrolysis of water or, alternatively, via direct photocatalytic water splitting. However, none of these techniques provide the efficiencies sufficient to be a practical means of hydrogen production and/or the electrode materials are not stable in the presence of sunlight, water, and galvanic currents.

Accordingly, it is desirable to provide a cost efficient method for generating hydrogen.

### SUMMARY OF THE INVENTION

A method for thermally activated photocatalytic generation of hydrogen from water, comprising: mixing a catalyst comprising a plurality of nanoparticles into a volume of water, wherein H₂O molecules adsorb onto the surface of the plurality of nanoparticles to form OH complexes, wherein the diameters of the plurality of nanoparticles are less than 35 nanometers; exposing the solution to sunlight, generating a plurality of electron hole pairs in the plurality of nanoparticles of the catalyst, wherein the electron hole pairs assist in the weakening of OH complexes on the surface of the plurality of nanoparticles to cause hydrogen atoms to thermally desorb from the OH complexes, and wherein the temperature of the solution is increased to be within the range of 110 to 140 degrees Fahrenheit, wherein the hydrogen atom thermal desorption rate is increased because of the temperature increase.

### BRIEF DESCRIPTION OF THE DRAWINGS

FIG. 1 are graphs illustrating hydrogen generated from water using catalysts of varying particle diameters;

FIGS. 2 and 3 are schematic illustrations of a photocatalytic decomposition of water in accordance with an exemplary embodiment of the present invention;

FIG. 4 are graphs illustrating the results of band structure calculations for an exemplary catalyst for use in exemplary embodiments of the present invention; and

FIGS. 5 and 6 are schematic illustrations of the generation of electron hole pairs in accordance with an exemplary embodiment of the present invention.

### DETAILED DESCRIPTION OF EXEMPLARY EMBODIMENTS

Reference is made to the following U.S. patent application Ser. No. 10/982,675 filed Nov. 5, 2004, the contents of which are incorporated herein by reference thereto.

Exemplary embodiments of the present invention relate to an efficient process for producing hydrogen (H₂) and oxygen (O₂) from water and sunlight. Exemplary embodiments relate to a green process involving only renewable resources e.g., water wherein H₂ and O₂ are recombined to form water. In accordance with an exemplary embodiment nano-particle catalyst powders 50 are used to split water molecules into H₂ and O₂ in the presence of sunlight wherein thermal activation is used to increase the desorption rate of the hydrogen from the catalyst surfaces. In accordance with an exemplary embodiment no electrodes, applied fields, ion or electron currents or intrinsic charge carrier densities are required in the water or particles in order to effect the thermal activation of the photocatalytic generation of the hydrogen.

In accordance with an exemplary embodiment nanoparticles are used to provide the photocatalytic generation of the hydrogen using thermal processes. Nanoparticles are particles with controlled dimensions on the order of nanometers. In accordance with an exemplary embodiment a photocatalytic decomposition of water is provided wherein the photoreaction is accelerated by the presence of a catalyst comprising nanoparticles.

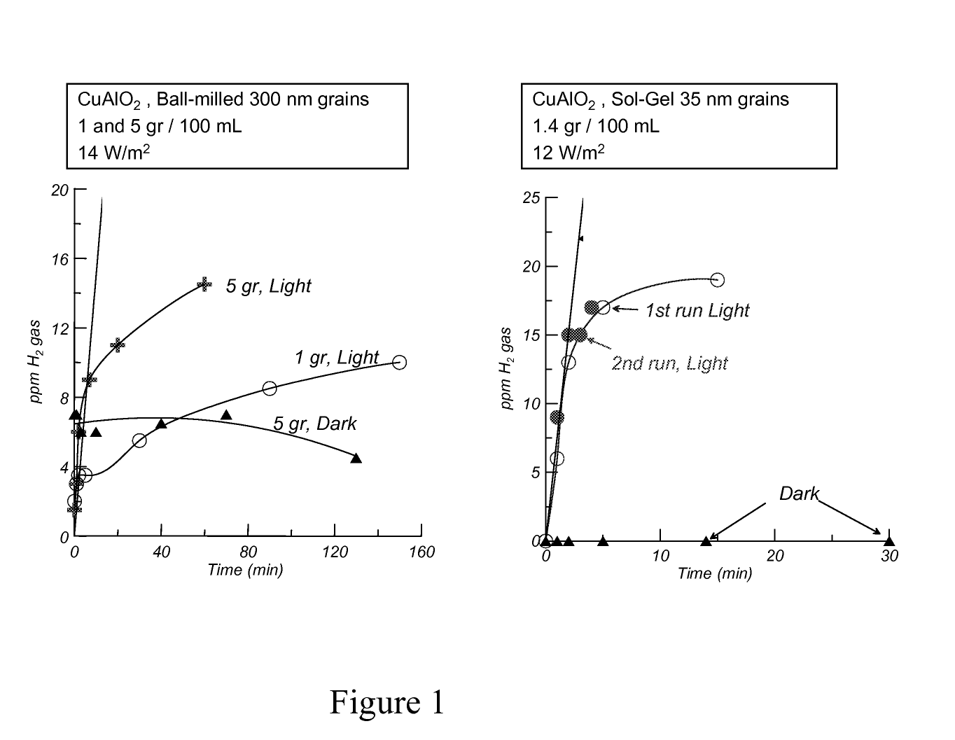

Attempts for such a photocatalytic decomposition of water are shown in the graphs of FIG. 1. While encouraging, it is desirable to increase the efficiency of hydrogen generation. This would minimize the area of the earth's surface required to produce a given amount of hydrogen.

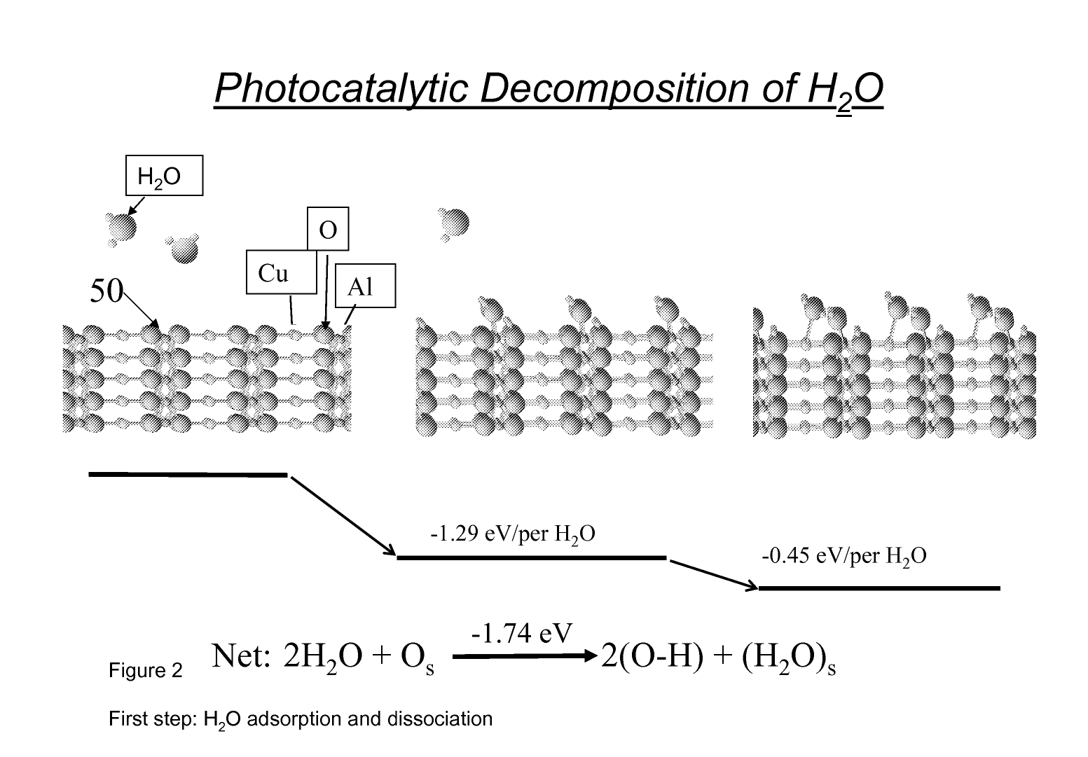

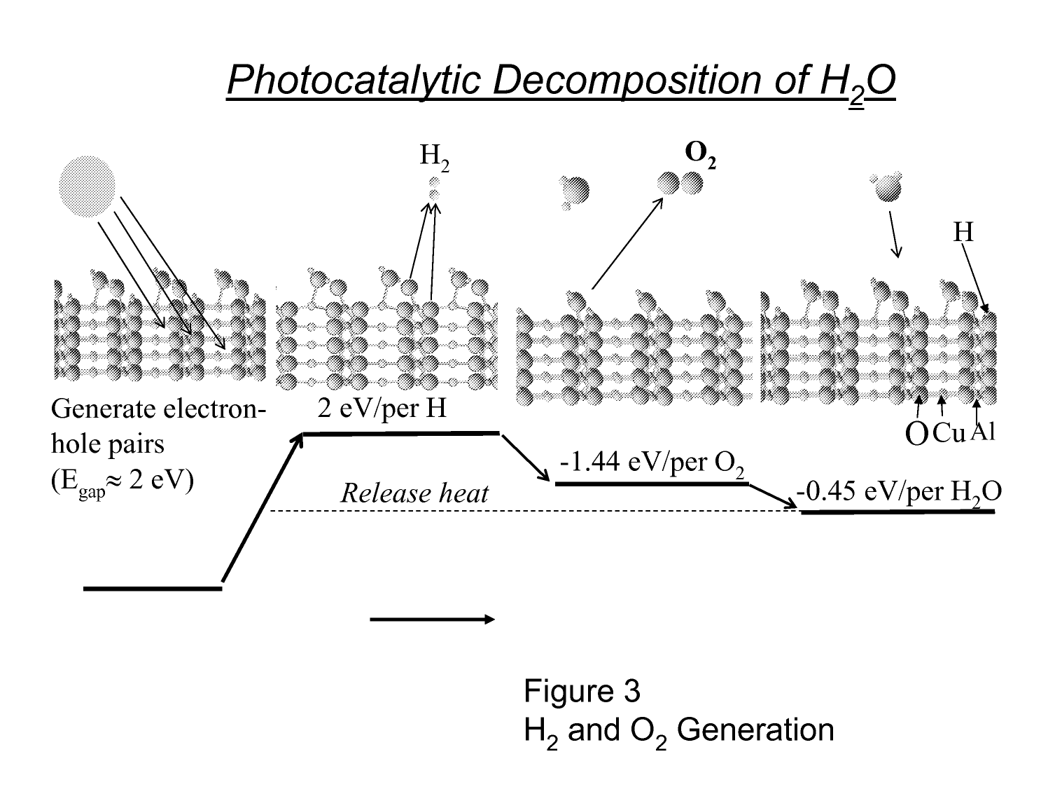

In accordance with an exemplary embodiment of the present invention, simulations based in part on the principles of the processes illustrated in FIG. 1 were used to provide a method to substantially increase hydrogen generation efficiency. The simulation is based on a model of the process represented in FIGS. 2 and 3. In one non-limiting exemplary embodiment a catalyst of CuAlO₂ is mixed with the water. The CuAlO₂ catalyst is comprised of nanoparticles having a diameter of approximately 30 nm. Of course other suitable catalysts comprising nanoparticles are considered to be with the scope of exemplary embodiments of the present invention.

The water splitting process occurs of in two steps. In the first step and as illustrated in FIG. 2, H₂O adsorbs on the catalyst CuAlO₂ surface and dissociates thereby forming OH complexes around the Al site with a net energy lowering of 1.29 eV per H₂O. This was computed by solving the Schrodinger Equation from first principles. Then H₂O adsorbs on the Cu site with an energy lowering of 0.45 eV per H₂O. In the second step and as illustrated in FIG. 3, H₂ desorbs, O₂ desorbs, and finally a water molecule adsorbs to complete the cycle.

It is clear from FIG. 3 that the rate-limiting step in H₂ generation is the desorption rate of H₂. Moreover, the energies shown in FIG. 3 are computed in absence of sunlight. Note in particular, the 2 eV desorption energy per H. One can see from FIG. 1 that in the dark the H₂ generation is negligible. This can be understood from the following thermal desorption rate equation,
ν_{D}=(νₒ/2)N_{H}exp(−E_{D}/kT). (Equation 1)

Here ν_{D} is the H₂ desorption rate, which is actually also the H₂ generation rate. Also νₒ=10¹³ per second, N_{H} is the total number of H atoms on the catalyst particle surfaces which can contribute to H₂ generation (FIG. 3), and E_{D} is the H₂ desorption energy per H atom. At room temperature for example 80 degrees Fahrenheit, an E_{D} of 2 eV yields a negligible H₂ desorption rate ν_{D} from Equation 1, consistent with the experimental data of FIG. 1. As used herein, a non-limiting reference for room temperature is 80 degrees Fahrenheit. In the presence of sunlight (FIG. 3), electron-hole pairs are created by photoexcitation of electrons by the sunlight. Because exemplary embodiments contemplate the use of nanoparticles, a significant number of the electron-hole pairs are able to migrate to the particle surfaces without recombining.

CuAlO₂ powders having particle diameters in the range of 30 to 300 nm were investigated experimentally (See FIG. 1). As the particle diameters are decreased the distance the electron hole pairs have to travel to the surface are reduced considerably.

In order to determine the appropriate particle size wherein recombination of the electron hole pairs is prevented, the below formula is provided.

$${L}_{D} = \sqrt{\frac{μ {k}_{B} T}{q} {τ}_{RECOMB}}$$

Wherein L_{D} is the diffusion length or distance electrons/holes move before recombining.
τ_{RECOMB}=Recombination Lifetime
μ=Mobility≈1 cm²/V.s
k_{B}=Boltsman's constant
q=charge on the electron

In accordance with an exemplary embodiment, the grain size or particle diameter d is presumed to be less than or equal to 100 nm (e.g., nanotechnology) and the photon absorption length Lₐ>>d.

Using the above calculations and based upon prior studies using TiO₂, L_{D} was calculated to be approximately 16 nm thus, a particle diameter less than approximately 35 nm will provide desirable results.

In accordance with an exemplary embodiment, the preferred CuAlO₂ diameters would be approximately 30 nm, because the electron-hole recombination distance would be expected to be of that order. In contrast, and referring to the 300 nm particles, only an outer shell of the particles would contribute electron-hole pairs to the catalyst surface, so the inner volume would not be directly active in the water splitting process. Moreover, since the surface to volume ratio varies as 1/r, where r=particle radius, it is also desirable to make r as small as possible to make the catalyst surface area as large as possible in order to increase the efficiency of the water splitting process of exemplary embodiments of the present invention. This is because the surface to volume ratio increases as the radius decreases.

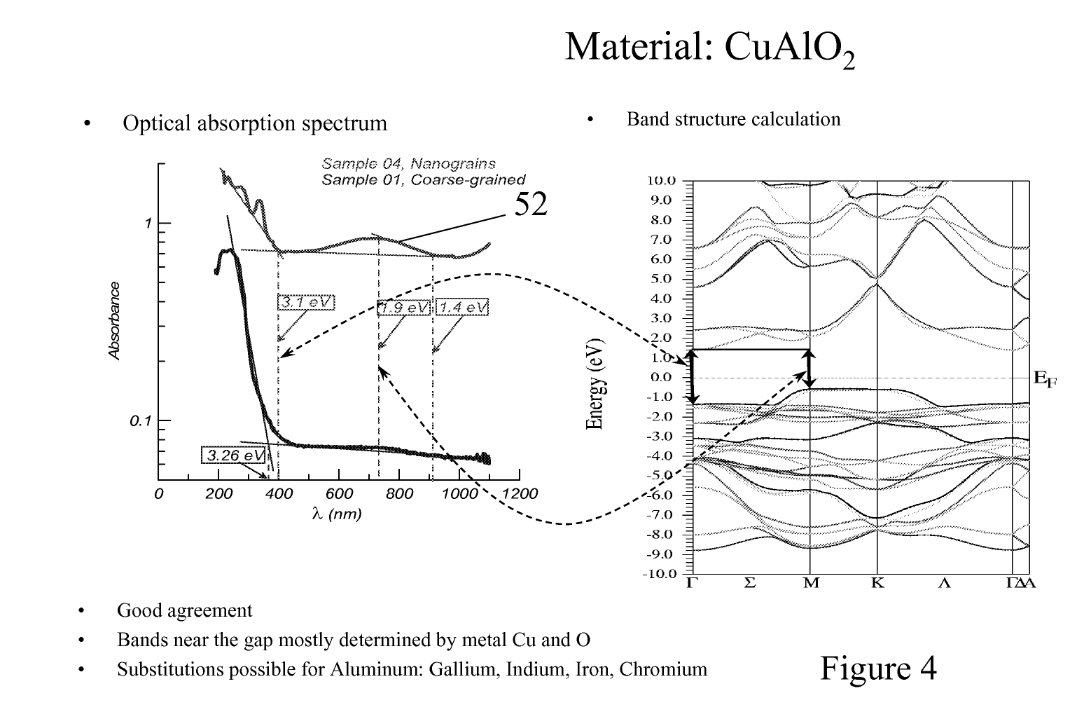

Moreover, the indirect gap in CuAlO₂ catalyst is approximately 1.9 eV, while the direct gap is 3.1 to 3.2 eV. Accordingly, the indirect gap allows a significantly larger portion of the solar spectrum to produce electron-hole pairs, so a larger efficiency is expected. As illustrated in FIG. 4 and as identified as line 52, the 30 nm particles have a much larger relative indirect-gap contribution. Therefore, it is desirable to use smaller (30 nm) particles wherein the indirect gap is more active and is consistent with the physics of the process.

It is, of course, understood that particles other than CuAlO₂ may be used as a catalyst wherein the benefits from smaller diameter powders are achieved. For example, it is contemplated that diameters of interest would be in the range of 1 nm to 1000 nm, and as small as is practical in that range. Of course, diameters outside this range are also contemplated to be within the scope of exemplary embodiments of the present invention. In accordance with an exemplary embodiment, other preferred particles would include any semiconductors with band gaps<about 3.5 eV.

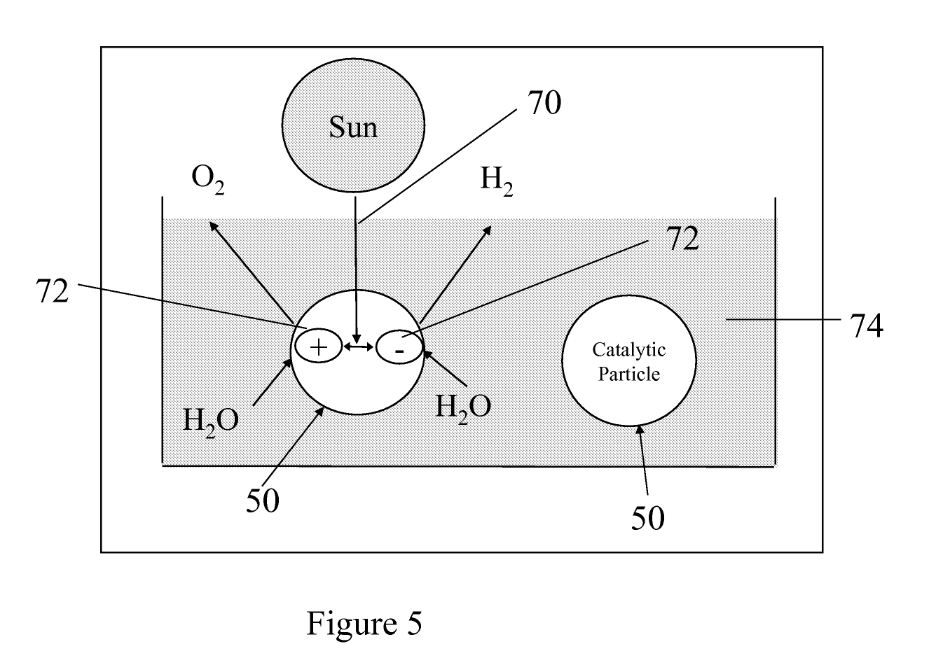

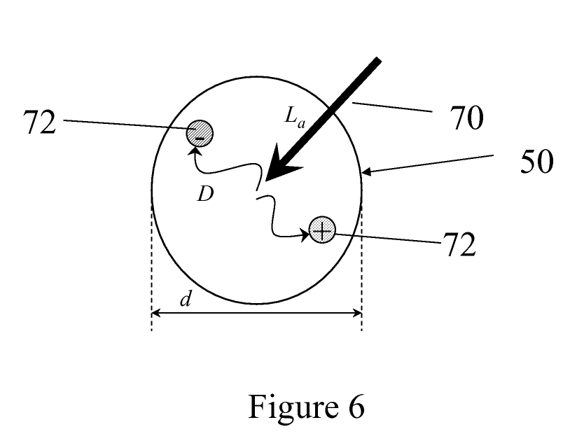

In accordance with an exemplary embodiment, the recombination distances or diffusion lengths of desirable catalyst materials are of the order 20 nm. See for example FIGS. 5 and 6, wherein the absorption of a photon 70 with energy equal to or greater than the band gap of the catalyst produces electron-hole (e⁻/e⁺) pairs 72 therefore and following the irradiation, the catalyst can act as an electron donor or acceptor for molecules in the surrounding media 74 (e.g., the water). FIG. 6 illustrates a nano-particle wherein due to its reduced diameter the electron-hole pairs are able to reach the surface before surface recombination or volume recombination of the electron hole pairs and thus the surface OH bonds are weakened.

In accordance with an exemplary embodiment, the surface OH bonds are weakened significantly in the presence of the electron-hole pairs. This is because when an electron-hole pair replaces the bonding electron between the O and H, it is as if this bonding electron were excited from the valence band to the conductance band. As such, the electron-hole pair is a much less effective bonding electron than is the original, ground-state bonding electron. So the OH bond strength is lowered thereby. With this weakened OH bond, the H atom can oscillate over a larger domain, with an increased probability of desorbing (lower ED, Equation 1). Ultimately, the desorbing H atom bonds with another desorbing H atom to form H₂. By equating the ν_{D} from Equation 1 to the experimental H₂ desorption rate (FIG. 1, where T=T_{R}=room temperature (e.g., 80 degrees Fahrenheit)), one can determine E_{D} in the presence of solar radiation, i.e., in the presence of electron-hole pairs. It turns out that for the data of FIG. 1, Equation 1 yields E_{D}=1.06 eV. So the solar radiation and consequent electron-hole pairs have lowered E_{D} from 2.0 eV to 1.06 eV. Note that while E_{D} has been lowered by electron-hole pairs, it is still a significant thermal barrier. This is an important point, because it means that the H atoms must thermally desorb.

This is very different from the usual galvanic or electrochemical methods of producing hydrogen and oxygen from water. In those processes, thermal desorption is not important for water splitting, and only that part of the solar spectrum in which the photon energies are greater than the electrode band gaps are active in splitting water. In the process of exemplary embodiments of the present invention, not only those photons of energy greater than the catalyst particle band gaps are active in the water-splitting process, but also the infrared part of the solar spectrum plays the important role of replacing the heat lost in the thermal desorption process and also of raising the water temperature above the ambient temperature. Accordingly, the process of an exemplary embodiment makes use of a much larger part of the solar spectrum. Moreover, electron-hole pairs that recombine will heat the water, and this energy will contribute to the process by increasing the temperature of the water.

Equation 1 shows how higher water temperatures can increase the hydrogen production rate ν_{D}. Note there that ν_{D} depends exponentially on 1/T. Accordingly, and if one were to raise the water temperature above room temperature (T_{R}), Table 1 below shows the ratio of ν_{D} at temperature T to its value at T_{R} as a function of T-T_{R} as computed from Equation 1. As illustrated, one can see that the H₂ production rate ν_{D} goes up very rapidly with temperature.

TABLE 1
H₂ production rate at temperature T relative
to its value at room temperature T_{R}.

| (H₂ rate at T)/(H₂ rate | | |
|---|---|---|
| at T_{R}) | (T − T_{R}), ° K | (T − T_{R}), ° F. |
| 2.01 | 5 | 9 |
| 3.96 | 10 | 18 |
| 14.33 | 20 | 36 |

In fact, at T-T_{R}=20° K., ν_{D} is over 14 times its value at room temperature, T_{R}.

In order to determine how robust this process of thermally-activated photocatalytic H₂ generation would be, suppose that not all the surface OH complexes that could contribute to H₂ production are active. This could occur if there were an inadequate generation rate of electron-hole pairs (i.e., if the catalyst band gap were too large), electron-hole annihilation rates were so large as to limit their availability at the catalyst particle surfaces, or the cross section for electron-hole pair transport to surface OH complexes were too small. To test for this, suppose that only one out of 10⁶ surface OH complexes take part in H₂ generation. This would represent an extreme case of weakening of the catalytic process. Then the thermal activation would be somewhat smaller, as shown in Table 2 below. However, the thermal effect is still relatively strong. For example, at T-T_{R}=30° K., ν_{D} is 12.9 times larger than at room temperature. Therefore and based upon Table 2, the thermal activation process is robust.

TABLE 2
H₂ production rate relative to room temperature
T_{R} if only one in 10⁶ surface OH bonds contribute.

| (H₂ rate at T)/(H₂ rate | | |
|---|---|---|
| at T_{R}) | (T − T_{R}), ° K | (T − T_{R}), ° F. |
| 1.59 | 5 | 9 |
| 2.48 | 10 | 18 |
| 5.80 | 20 | 36 |
| 12.9 | 30 | 54 |

Accordingly, exemplary embodiments of the present invention presume that the rate limiting step to hydrogen generation is the thermal barrier to H atom desorption. For a sufficiently high temperature T, the desorption rate over this barrier may be sufficiently high that another effect becomes rate limiting. For example, the electron-hole pair supply rate to the surface OH bonds may not be able to keep up with the H atom desorption rate at a sufficiently high temperature. This could be formulated in Equation 1 by introducing a temperature dependence of N_{H}=N_{H}(T). The temperature at which another effect becomes rate limiting would depend on such properties as the catalyst particle material, its diameter, and the intensity of the solar radiation. A non-limiting range of suitable temperatures is defined as follows: T_{R} to T_{R}+200 degrees Fahrenheit.

In accordance with an exemplary embodiment, one non-limiting means for heating the water above room temperature with only solar radiation would be to dispose the solution of water and catalyst particles in an enclosure wherein solar radiation is allowed to heat the water and the thermal increase in temperature is retained and hydrogen gas is produced and captured. Thereafter, a conduit in fluid communication with the enclosure will siphon off the produced hydrogen gases.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application

What is claimed is:

1. A method for thermally activating photocatalytic generation of hydrogen from water, comprising:
mixing a catalyst comprising a plurality of nanoparticles into a volume of water, wherein H₂O molecules adsorb onto the surface of the plurality of nanoparticles to form OH complexes, wherein the diameters of the plurality of nanoparticles are less than 35 nanometers;
exposing the solution to sunlight, wherein a temperature of the solution is increased to be within the range of 110 to 140 degrees Fahrenheit; and
wherein a plurality of electron hole pairs is generated in the plurality of nanoparticles of the catalyst, wherein the electron hole pairs assist in the weakening of OH complexes on the surface of the plurality of nanoparticles to cause hydrogen atoms to thermally desorb from the OH complexes.

2. The method as in claim 1, wherein the catalyst is CuAlO₂.

3. The method as in claim 1, wherein the catalyst is a semiconductor that has a direct band gap less than about 3.5 eV.

4. The method as in claim 1, wherein the catalyst is a semiconductor that has an indirect band gap less than about 3.5 eV.

5. The method as in claim 1, wherein the plurality of electron hole pairs are generated without an electrical current being applied to the catalyst.

6. A mixture for generating hydrogen, comprising:
a photocatalyst suspended in water, wherein the photocatalyst comprises a plurality of nanoparticles having diameters less than 35 nanometers, wherein molecules of the water adsorb onto the surface of the plurality of nanoparticles to form OH complexes and electron hole pairs in the plurality of nanoparticles assist in the weakening of OH bonds on the surface of the plurality of nanoparticles to cause hydrogen atoms to thermally desorb from the OH complexes, when the temperature of the solution is within the range of 110 to 140 degrees Fahrenheit.

7. The solution as in claim 6, wherein the photocatalyst is CuAlO₂.

8. The solution as in claim 6, wherein the photocatalyst is semiconductor that has a direct band gap less than about 3.5 eV.

9. A method for thermally generating activating photocatalytic generation of hydrogen from water, comprising:
mixing a catalyst comprising a plurality of nanoparticles into a volume of water to generate a solution, wherein H₂O molecules adsorb onto the surface of the plurality of nanoparticles to form OH complexes, wherein the diameters of the plurality of nanoparticles are in a range defined by 1-1000 nanometers;
exposing the solution to sunlight, wherein a temperature of the solution is increased by the sunlight to be within the range of 110 to 140 degrees Fahrenheit; and
generating a plurality of electron hole pairs in the plurality of nanoparticles of the catalyst, wherein the electron hole pairs assist in the weakening of OH complexes on the surface of the plurality of nanoparticles to cause hydrogen atoms to thermally desorb from the OH complexes.

10. A method for thermally activating photocatalytic generation of hydrogen from water, comprising:
mixing a catalyst comprising a plurality of nanoparticles into a volume of water to generate a solution, wherein H₂O molecules adsorb onto the surface of the plurality of nanoparticles to form OH complexes, wherein the diameters of the plurality of nanoparticles are in a range defined by 1-1000 nanometers;
exposing the solution to sunlight, wherein a temperature of the solution is increased to be within a range defined by room temperature to room temperature plus 200 degrees Fahrenheit; and
generating a plurality of electron hole pairs in the plurality of nanoparticles of the catalyst, wherein the electron hole pairs assist in the weakening of OH complexes on the surface of the plurality of nanoparticles to cause hydrogen atoms to thermally desorb from the OH complexes.
